(19) United States
(12) Patent Application Publication
(10) Pub. No.: US 2004/0263453 A1
(43) Pub. Date: Dec. 30, 2004

(54) Liquid crystal display device and method of fabricating the same

(75) Inventors: Sang Chang Yun, Kyoungsangbuk-do (KR); Jae Woo Lee, Kyoungsangbuk-do (KR)

Correspondence Address: MORGAN LEWIS & BOCKIUS LLP, 1111 PENNSYLVANIA AVENUE NW, WASHINGTON, DC, 20004, US

(73) Assignee: LG.Philips LCD Co., Ltd.

(21) Appl. No.: 10/875,735

(22) Filed: Jun. 25, 2004

(30) Foreign Application Priority Data
Jun. 25, 2003 (KR) P-2003-41607

(51) Int. Cl. G09G 3/36

(52) U.S. Cl. 345/87

(57) ABSTRACT

A liquid crystal display device includes liquid crystal cells formed at crossings of data lines and gate lines, driving thin film transistors connected to the liquid crystal cells, respectively, to provide a desired video signal to the liquid crystal cells, and pre-charging thin film transistors connected to the liquid crystal cells, respectively, to pre-charge a specified voltage prior to providing the desired video signal to the liquid crystal cells.

The present invention claims the benefit of Korean Patent Application No. P2003-41607 filed in Korea on Jun. 25, 2003, which is hereby incorporated by reference.

### BACKGROUND OF THE INVENTION

1. Field of the Invention

The present invention relates to a liquid crystal display device and a method of driving the same, and more particularly, to a liquid crystal display device and a method of driving the same for pre-charging liquid crystal cells to achieve high speed driving.

2. Description of the Related Art

In general, a liquid crystal display device (LCD) controls light transmittance of liquid crystal cells in accordance with video signals to display a picture corresponding to the video signals. Such a LCD includes a liquid crystal display panel having liquid crystal cells arranged in a matrix, and driving circuits for driving the liquid crystal panel.

In the liquid crystal display panel, gate lines and data lines cross each other. Liquid crystal cells are provided at areas defined by crossings of the gate lines and the data lines, respectively. The liquid crystal display panel is provided with pixel electrodes and a common electrode for applying an electric field to the liquid crystal cells. Each pixel electrode is connected, via a thin film transistor (TFT) as a switching device, to one of the data lines. A gate terminal of the TFT is connected to one of the gate lines so that a video signal is provided to the pixel electrodes by each line. Each of the driving circuits includes a gate driver to drive the gate lines, a data driver to drive the data lines, and a common voltage generator to drive the common lines.

The gate driver sequentially applies a scanning signal, i.e., a gate signal, to the gate lines to sequentially drive the liquid crystal cells on the liquid crystal display panel one line at a time. Whenever a gate signal is provided to any one of the gate lines, the data driver applies a video signal to each of the data lines. The common voltage generator supplies a common voltage signal to the common electrode. Accordingly, an arrangement of the liquid crystal materials between the pixel electrode and the common electrode is changed so that the light transmittance is modulated for each liquid crystal cell in accordance with the video signal cells, whereby a picture is displayed on the liquid crystal display device.

FIG. 1 is a schematic diagram illustrating a liquid crystal display device in accordance with related art. As depicted in FIG. 1, the liquid crystal display device includes a liquid crystal display panel 2, a gate driver 4 and a data driver 6. The liquid crystal display panel 2 includes liquid crystal cells Clc arranged in a matrix. The gate driver 4 drives gate lines GL1 to GLn of the liquid crystal display panel. The data driver 6 drives data lines DL1 to DLm of the liquid crystal display panel 2.

In FIG. 1, the liquid crystal display panel 2 includes thin film transistors TFTs arranged at crossings of n-number of gate lines GL1 to GLn and m-number of data lines DL1 to DLm. Each of the thin film transistors TFTs applies video signals from the data lines DL1 to DLm to the liquid crystal cells in response to gate signals from the gate lines GL1 to GLn. Each of the liquid crystal cells, which can be equivalently represented as a liquid crystal capacitance capacitor Clc, includes a common electrode, a pixel electrode facing the common electrode and connected to the thin film transistor, and a liquid crystal arranged between the common electrode and the pixel electrode.

The storage capacitor is positioned between a previous gate electrode and a pixel electrode. The gate driver 4 sequentially provides the gate signals to the gate lines GL1 to GLn to drive the thin film transistors TFTs connected to corresponding gate lines. The data driver 6 converts video data to analog video signals and applies one line of the converted video signals to the data lines DL1 to DLm during one horizontal interval for supplying the gate signal to the gate line. In this regard, the data driver 6 converts the video data to the video signals using gamma voltages supplied from a gamma voltage generator (not shown).

In order to drive the liquid crystal cells on the liquid crystal display panel, the liquid crystal display device can employ an inversion driving method. Inversion driving methods include a frame inversion system, a line (column) inversion system, and a dot inversion system. In the frame inversion system for driving the liquid crystal display panel, the polarities of the video signals applied to the liquid crystal cells on the liquid crystal display panel are inverted whenever a frame is changed.

FIGS. 2A and 2B are diagrams illustrating a line inversion driving system of a liquid crystal display in accordance with related art. In the line inversion system for driving the liquid crystal display panel, the polarities of the video signals applied to the liquid crystal display panel are inverted for each gate line of the liquid crystal display panel and, thus, for each frame. Such a line inversion system suffers from crosstalk between pixels in a horizontal direction. Crosstalk cause flickers such as stripe patterns generated between horizontal lines.

FIGS. 3A and 3B are diagrams explaining a column inversion driving system of a liquid crystal display in accordance with related art. In the column inversion system for driving the liquid crystal display panel, the polarities of the video signals applied to the liquid crystal display panel are inverted for each data line of the liquid crystal display panel and, thus, for each frame. The column inversion system suffers from crosstalk between pixels in a vertical direction. Crosstalk cause flickers such as stripe patterns generated between vertical lines.

FIGS. 4A and 4B are diagrams explaining a dot inversion driving system of a liquid crystal display in accordance with related art. In the dot inversion system for driving the liquid crystal display panel, video signals applied to each liquid crystal cell have opposite polarities with respect to vertically or horizontally adjacent LCD cells. The polarities of the video signals are inverted for each frame.

More specifically, in the dot inversion system, when video signals of an odd-numbered frame are displayed, the video signals are supplied to each of the liquid crystal cells such that a positive (+) polarity and a negative (−) polarity alternately appears to progress from top-left to right and down to the bottom in the liquid crystal cells, as shown in FIG. 4A. When video signals of an even-numbered frame are displayed, the video signals are supplied to each of the liquid crystal cells such that a negative (−) polarity and a positive (+) polarity alternately appears to progress from top-left to right and down to the bottom in the liquid crystal cells. In the dot inversion driving method, flickers occurring among adjacent pixels in a vertical direction and a horizontal direction cancel each other. By this arrangement, pictures of better quality than the other inversion systems can be displayed.

However, in the dot inversion driving method, since the polarity of the video signal applied from the data driver to the data lines is inverted in a vertical and a horizontal direction, there is a disadvantage in that the dot inversion driving method consumes more power than the other inversion systems. More power is required because of the high variation in pixel voltage, which corresponds to a high frequency of the video signal. In order to overcome the described disadvantages, a liquid crystal display device as depicted in FIG. 5 has been proposed.

FIG. 5 is a schematic diagram illustrating a liquid crystal display in accordance with other related art. Referring to FIG. 5, the liquid crystal display in accordance with this related art includes a liquid crystal display panel 12 having liquid crystal cells arranged in a matrix, a gate driver 14 for driving n-number of gate lines GL1 to GLn of the liquid crystal display panel 12, a data driver 16 for driving m+1 number of data lines DL1 to DLm+1 of the liquid crystal display panel 12, and a timing controller 18 for controlling the gate driver 14 and the data driver 16.

The liquid crystal display 12 includes the gate lines GL1 to GLn and the data lines DL1 to DLm+1 isolated from and crossing the gate lines GL1 to GLn. The liquid crystal display panel 12 further includes the liquid crystal cells formed between the gate lines GL1 to GLn and the data lines DL1 to DLm+1. Each of the liquid crystal cells is connected to a thin film transistor 11 that is connected to one of the gate lines GL1 to GLn and one of the data lines DL1 to DLm+1.

The thin film transistor 11 is arranged in a zigzag pattern, and therefore the liquid crystal cells are connected to each of the data lines DL1 to DLm+1 in a zigzag pattern. For example, the liquid crystal cells in odd-numbered horizontal lines connected to the odd-numbered gate lines GL1, GL3, GL5, . . . are connected to a first to m data lines DL1 to DLm positioned in an −X axis direction with respect to the liquid crystal cells, respectively. Similarly, the liquid crystal cells in even-numbered horizontal lines connected to the even-numbered gate lines GL2, GL4, GL6, . . . are connected to a second to (m+1)-numbered data lines DL2 to DLm+2 positioned in an +X axis direction with respect to the liquid crystal cells, respectively.

Accordingly, the odd-numbered data lines DL1, DL3, . . . are alternately connected to the odd-numbered liquid crystal cells and the even-numbered liquid crystal cells for each horizontal line. Similarly, the even-numbered data lines DL2, DL4, . . . are alternately connected to the even-numbered liquid crystal cells and the odd-numbered liquid crystal cells for each horizontal line.

The thin film transistors 11 provide the video signals from the data lines DL1 to DLm+1 to the liquid crystal cells in response to the gate signals from the gate lines GL1 to GLn. The liquid crystal cells drive the liquid crystals arranged between common electrodes (not shown) and the pixel electrodes 13 to control the light transmittances in response to the video signals.

The gate driver 14 sequentially provides the gate signals to the gate lines GL1 to GLn to drive the thin film transistors TFTs connected to their corresponding gate lines. The data driver 16 converts input video data to analog video signals and applies the converted video signals one horizontal line at a time to the data lines DL1 to DLm+1 during one horizontal interval for supplying a gate signal to a gate line GL. In this regard, the data driver 16 converts the video data to the video signals using gamma voltages supplied from a gamma voltage generator (not shown). The data driver 16 supplies the converted video signals to the data lines DL1 to DLm+1 by the column inversion driving method.

Specifically, the data driver 16 provides the video signals having alternately inverted polarities to the odd-number data lines DL1, DL3, . . . and the even-numbered data lines DL2, DL4, . . ., respectively, for each frame. In particular, the data driver 16 provides the original video signals or the video signals shifted by a channel in a right direction to the liquid crystal cells arranged in the zigzag pattern for each horizontal interval. Accordingly, because the data driver 16 is driven by the column inversion method and provides the original video signals or the video signals shifted by a channel in a right direction for each horizontal interval, the liquid crystal cells arranged in the zigzag pattern along the data lines DL1 to DLm+1 can be driven by the dot inversion method.

For example, if the data driver 16 drives the liquid crystal panel 12 as depicted in FIG. 5, the video signals on the odd-numbered horizontal lines will be supplied to the first to m-th data lines DL1 to DLm, respectively, while the video signals on the even-numbered horizontal lines will be shifted by a channel and then supplied to the second to (m+1)th data lines DL2 to DLm+1, respectively. Specifically, the data driver 16 provides the video signals having a positive (+) polarity to the odd-numbered liquid crystal cells through the odd-numbered data lines DL1, DL3, . . . during one horizontal interval for which a first gate line GL1 is driven, while providing the video signals having a negative polarity to the even-numbered liquid crystal cells through the even-numbered data lines DL2, DL4, . . . during the horizontal interval. Subsequently, during one horizontal interval for which a second gate line GL2 is driven, the data driver 16 shifts the video signals by a channel in a right direction and then provides the shifted video signals having a negative polarity to the odd-numbered liquid crystal cells through the even-numbered data lines DL2, DL4, . . ., while providing the video signals having a positive(+) polarity to the even-numbered liquid crystal cells through the odd-numbered data lines DL3, DL5, . . . except the first data line DL1. Accordingly, because the data driver 16 is driven by the column inversion method and provides the video signals shifted by a channel for each horizontal line to the liquid crystal cells arranged in the zigzag pattern along the data lines DL1 to DLm+1, the liquid crystal cells in the liquid crystal panel 12 can be driven by the dot inversion method.

In the related art liquid crystal display device described above, the liquid crystal cells are arranged in the zigzag pattern along the data lines and are driven by the dot inversion method using the data driver of the column inversion method. By this scheme, it is possible for the related art liquid crystal display device to reduce power consumption.

However, the related art liquid crystal display devices as shown in FIG. 1 and FIG. 5 have a drawback that the data cannot be charged fast enough in the liquid crystal cells due to a slow response property of the liquid crystal cells. That is, the video signals are not charged fast enough in the liquid crystal cells for the turn-on duration of the thin film transistor. Accordingly, the related art liquid crystal display devices have difficulty carrying out the fast driving required for displaying fast moving images.

### SUMMARY OF THE INVENTION

Accordingly, the present invention is directed to a liquid crystal display device and a method of fabricating the same that substantially obviate one or more of the problems due to limitations and disadvantages of the related art.

An object of the present invention is to provide a liquid crystal display device with fast driving characteristics.

Another object of the present invention is to provide a method that enables fast driving of a liquid display device.

Additional features and advantages of the invention will be set forth in the description which follows, and in part will be apparent from the description, or may be learned by practice of the invention. These and other advantages of the invention will be realized and attained by the structure particularly pointed out in the written description and claims hereof as well as the appended drawings.

To achieve these and other advantages and in accordance with the purpose of the present invention, as embodied and broadly described herein, the liquid crystal display device includes liquid crystal cells formed at crossings of data lines and gate lines, driving thin film transistors connected to the liquid crystal cells, respectively, to provide a desired video signal to the liquid crystal cells, and pre-charging thin film transistors connected to the liquid crystal cells, respectively, to pre-charge a specified voltage prior to providing the desired video signal to the liquid crystal cells.

In another aspect, the liquid crystal display device includes a liquid crystal panel which includes liquid crystal cells formed at crossings of gate lines and data lines and arranged in a zigzag pattern along the data lines, driving thin film transistors connected to the liquid crystal cells, respectively, and arranged in a zigzag pattern at a left side and a right side of the data lines, the driving thin film transistors for providing a desired video signal to the liquid crystal cells, and pre-charging thin film transistors connected to the liquid crystal cells, respectively, the pre-charging thin film transistors for pre-charging a specified voltage to the liquid crystal cells prior to providing the desired video signal to the liquid crystal cells.

In another aspect, the method of driving a liquid crystal display device includes pre-charging liquid crystal cells located at a current horizontal line using a previous video signal corresponding to a previous horizontal line, and providing a current video signal to the pre-charged liquid crystal cells to charge a desired video signal in the pre-charged liquid crystal cells, the current video signal corresponding to the current horizontal line.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a unit of this specification, illustrate embodiments of the invention and together with the description serve to explain the principles of the invention. In the drawings:

FIG. 1 is a schematic diagram of a liquid crystal display device in accordance with related art;

FIGS. 2A and 2B are diagrams of a line inversion driving system of a liquid crystal display in accordance with related art;

FIGS. 3A and 3B are diagrams describing a column inversion driving system of a liquid crystal display in accordance with related art;

FIGS. 4A and 4B are diagrams describing a dot inversion driving system of a liquid crystal display in accordance with related art;

FIG. 5 is a schematic diagram describing a liquid crystal display in accordance with other related art;

FIG. 6 is an exemplary schematic diagram of a liquid crystal display device in accordance with an embodiment of the present invention;

FIG. 7 is an exemplary schematic diagram of a liquid crystal display device in accordance with another embodiment of the present invention;

FIG. 8 is an exemplary schematic diagram of a liquid crystal display device in accordance with another embodiment of the present invention;

FIG. 9 is an exemplary schematic diagram of a liquid crystal display device in accordance with yet another embodiment of the present invention; and

FIG. 10 is an exemplary schematic diagram of a liquid crystal display device in accordance with still another embodiment of the present invention.

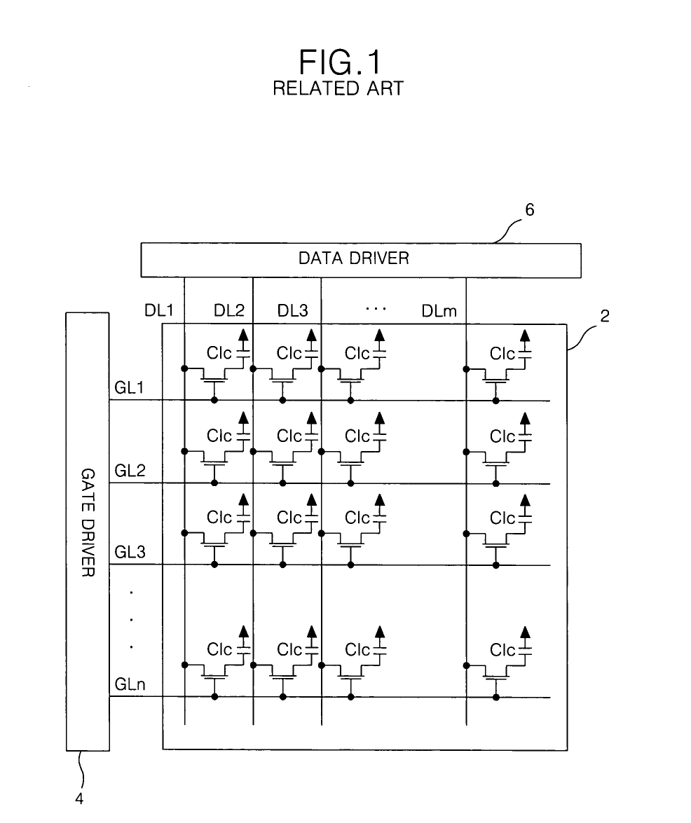

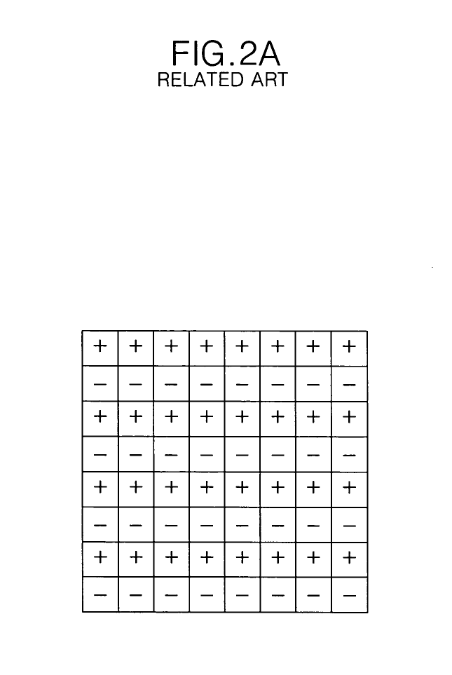

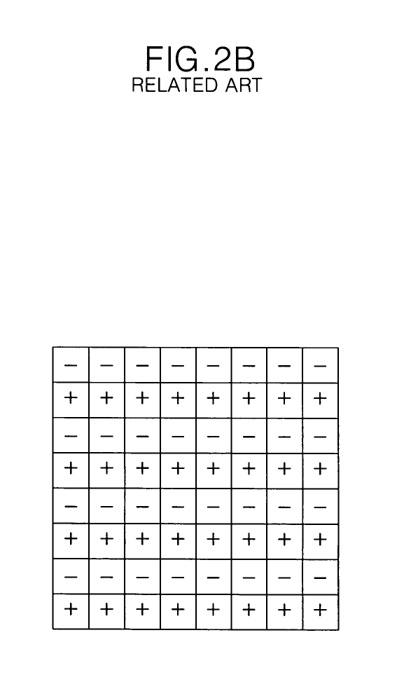

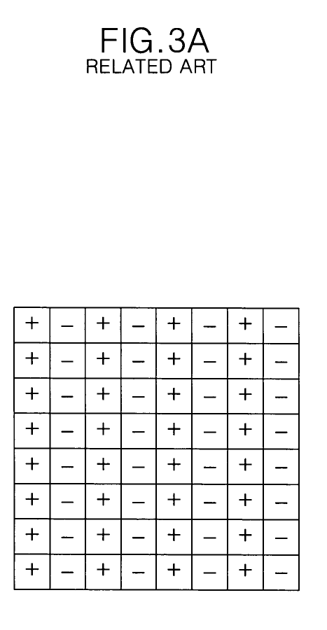

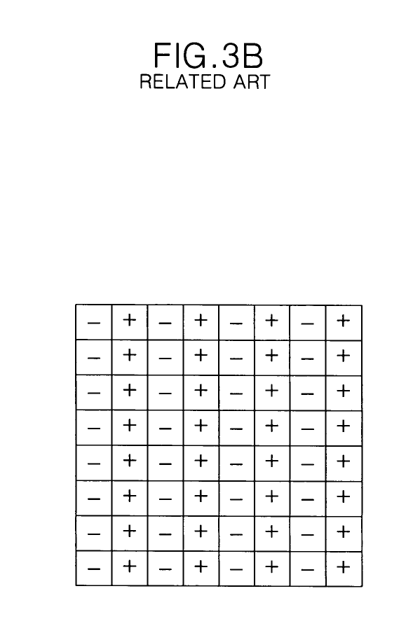

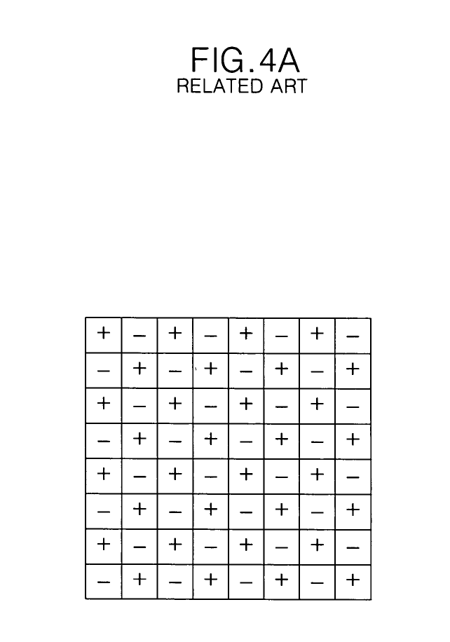

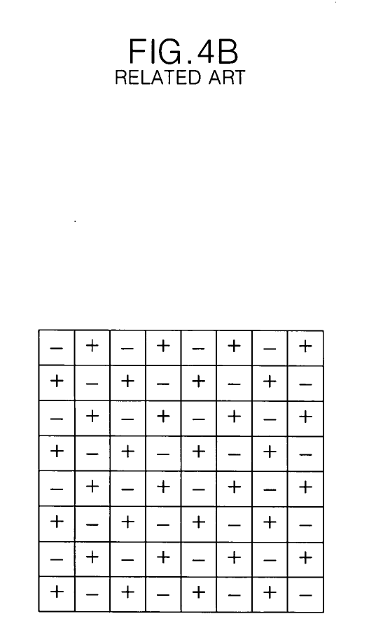

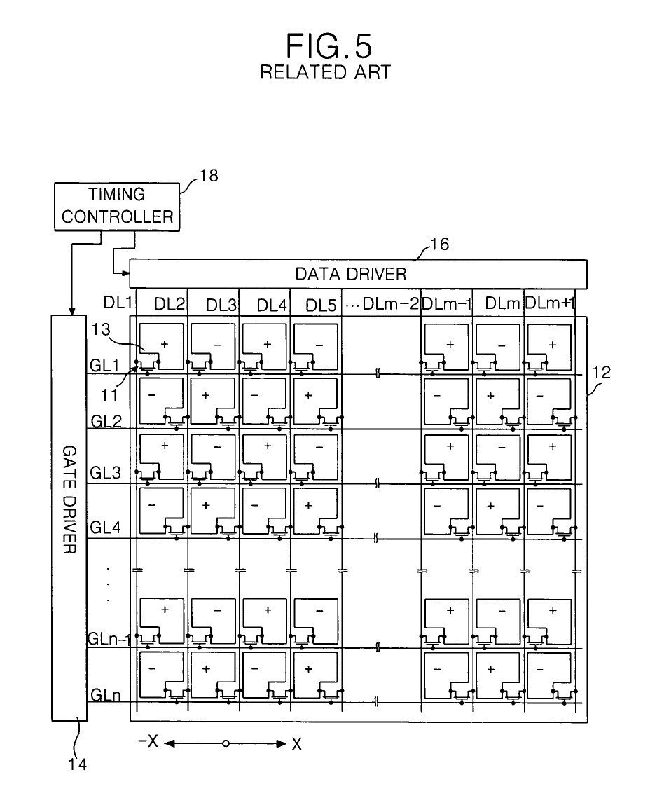

### DETAILED DESCRIPTION OF THE PREFERRED EMBODIMENTS

Reference will now be made in detail to the preferred embodiments of the present invention, examples of which are illustrated in the accompanying drawings.

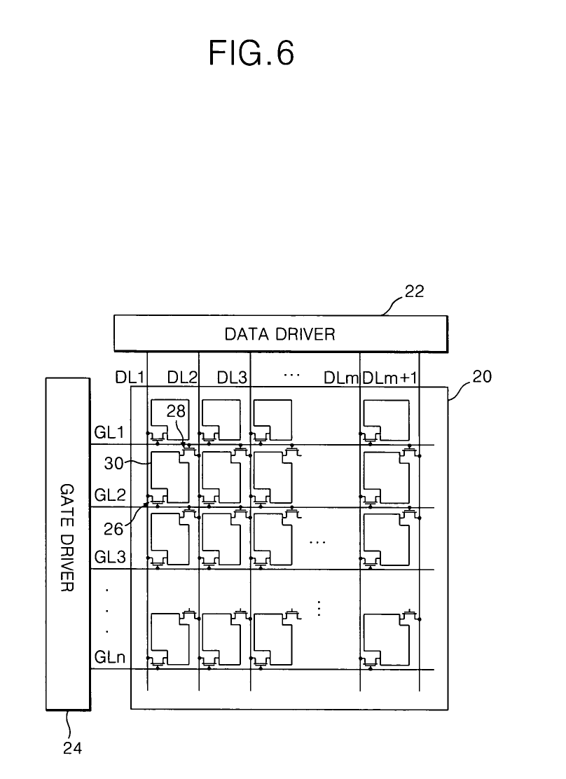

FIG. 6 is an exemplary schematic diagram of a liquid crystal display device in accordance with a preferred embodiment of the present invention. Referring to FIG. 6, the liquid crystal display device includes a liquid crystal display panel 20, a gate driver 24 for driving n-number of gate lines GL1 to GLn of the liquid crystal display panel 20, a data driver 22 for driving m+1 number of data lines DL1 to DLm+1 of the liquid crystal display panel 20.

The liquid crystal display panel 20 includes liquid crystal cells arranged in a matrix. The liquid crystal cells, in response to video signals, drive liquid crystals arranged between a common electrode (not shown) and a pixel electrode 30 to modulate a light transmittance. The liquid crystal display panel 20 further includes driving thin film transistors (hereinafter driving TFTs) 26 and pre-charging thin film transistors (hereinafter pre-charging TFTs) 28. The driving TFTs and the pre-charging TFTs are each connected to a liquid crystal cell, respectively.

A driving TFT 26 formed at its corresponding liquid crystal cell is connected to both an i-numbered gate line and a j-numbered data line. Herein, each of i and j represents a natural number. Therefore, the driving TFT, in response to a gate signal from the i-numbered gate line, provides a video signal from the j-numbered data line to the liquid crystal cell. The liquid crystal cell displays a picture corresponding to the video signal provided from the driving TFT 26.

The pre-charging thin film transistor 28 formed at the corresponding liquid crystal cell is connected to both an (i−1)-numbered gate line and a (j+1)-numbered data line. Therefore, the pre-charging TFT 28, in response to a gate signal from the (i−1)-numbered gate line, provides a video signal from the (j+1)-numbered data line to the liquid crystal cell. The video signal provided through the pre-charging TFT 28 is pre-charged in the liquid crystal cell. More specifically, the liquid crystal cell is pre-charged by the video signal provided through the pre-charging TFT 28. Then, the liquid crystal cell is provided with the video signal from the driving TFT 26. Accordingly, rapid charging of the liquid crystal cell with the video signal provided from the driving TFT 26 can be achieved.

During operation of the liquid crystal panel, the driving TFTs 26 located at a second horizontal line are turned-on when a gate signal is provided to a second gate line GL2. The video signal provided to the data lines DL1 to DLm+1 is then supplied to the liquid crystal cells located at the second horizontal line via the turned-on driving TFTs 26. Concurrently, the pre-charging TFTs 28 located at a third horizontal line are turned-on when the gate signal is provided to the second gate line GL2. Therefore, the video signal provided to the data lines DL1 to DLm+1 is supplied to the liquid crystal cells located at the third horizontal line via the turned-on pre-charging TFTs 28. Thus, the pre-charging TFTs 28 provide an amount of data corresponding to a previous horizontal line to the liquid crystal cells in a current horizontal line.

Thereafter, the driving TFTs 26 located at the third horizontal line are turned-on when a gate signal is provided to a third gate line GL3. The video signal provided to the data lines DL1 to DLm+1 is then supplied to the liquid crystal cells located at the third horizontal line via the turned-on driving TFTs 26. Accordingly, because the liquid crystal cells located at the third horizontal line have been pre-charged, a voltage corresponding to a desired video signal can rapidly be charged in the liquid crystal cells.

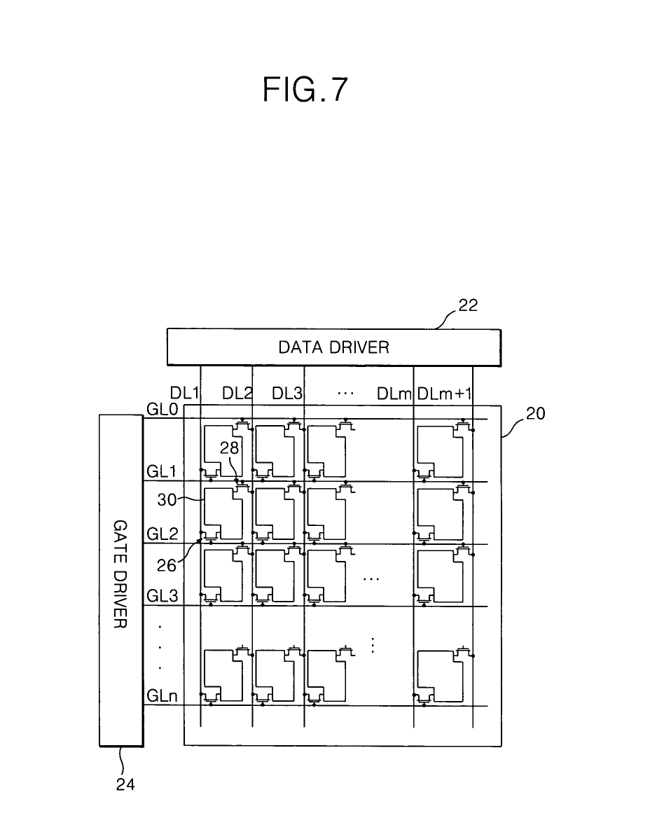

Further, as shown in FIG. 6, the liquid crystal cells located at the first horizontal line only include the driving TFTs 26. In accordance with this particular embodiment, the liquid crystal cells located at the first horizontal line cannot pre-charge the video signal therein. In order to solve the problem, in accordance with another embodiment of the present invention, pre-charging TFTs are provided to the liquid crystal cells located at a first horizontal line, respectively, and a gate line GL0 is provided for connecting the pre-charging TFTs, as shown in FIG. 7. In addition, the liquid crystal cells located at the first horizontal line are pre-charged with dummy data generated from the data driver 22 during an interval for driving the gate line GL0.

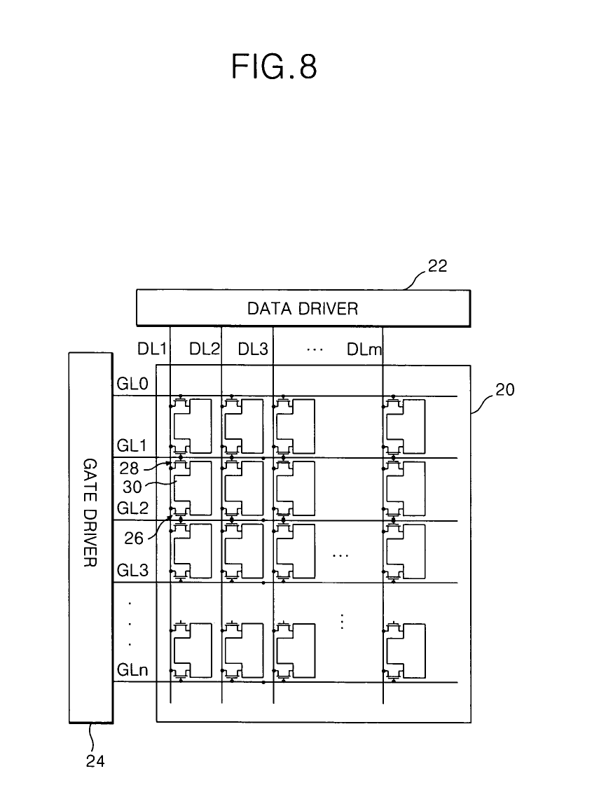

FIG. 8 is an exemplary schematic diagram of a liquid crystal display device in accordance with another embodiment of the present invention. In FIG. 8, the location of the pre-charging TFTs is modified. The pre-charging TFTs and the driving TFTs are connected to the same data line. More specifically, as depicted in FIG. 8, the driving TFT 26 is connected to its corresponding liquid crystal cell at an i-numbered gate line and a j-numbered data line. The pre-charging TFT 28 is connected to the corresponding liquid crystal cell at an (i−1)-numbered gate line and the j-numbered data line. The operation of the liquid crystal display device shown in FIG. 8 is similar to that of the liquid crystal display device shown in FIG. 6. Accordingly, the detailed description therefor will be omitted for the sake of simplicity.

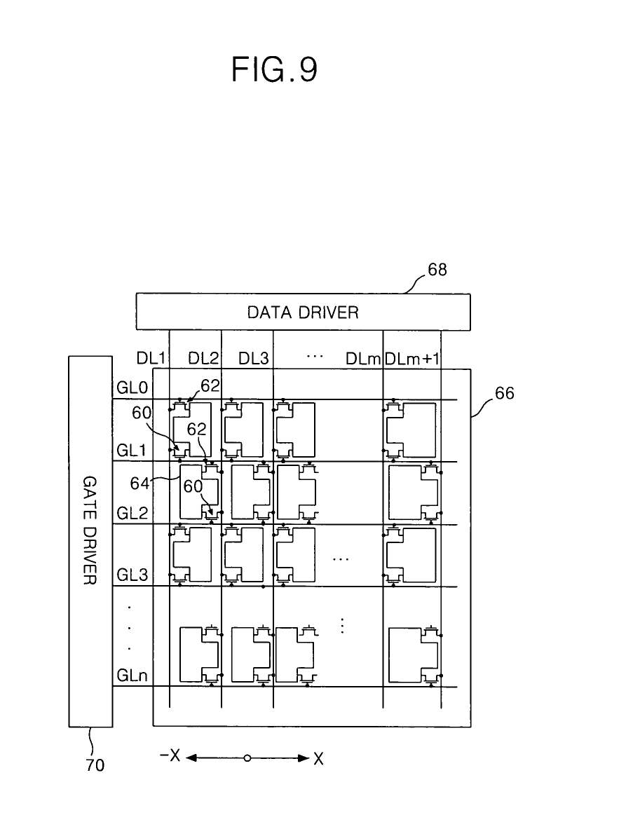

FIG. 9 is an exemplary schematic diagram of a liquid crystal display device in accordance with yet another embodiment of the present invention. As shown in FIG. 9, the liquid crystal display device includes a liquid crystal display panel 66, a gate driver 70 for driving n-number of gate lines GL1 to GLn of the liquid crystal display panel 66, a data driver 68 for driving m+1 number of data lines DL1 to DLm+1 of the liquid crystal display panel 66.

The liquid crystal display panel 66 includes liquid crystal cells arranged in a matrix. The liquid crystal cells drive liquid crystals arranged between a common electrode (not shown) and a pixel electrode 64 to modulate a light transmittance in response to video signals. The liquid crystal display panel 20 further includes driving TFTs 60 and pre-charging TFTs 62, each of the driving and pre-charging TFTs being connected to a liquid crystal cell, respectively.

The driving TFTs 60 are arranged in a zigzag pattern along the data lines DL1 to DLm+1. Thus, the liquid crystal cells are also connected to the data lines DL1 to DLm+1 in the zigzag pattern, respectively. Specifically, the driving TFTs corresponding to liquid crystal cells which belong in a same column are alternately connected to adjacent data lines DL for each horizontal line.

For example, as depicted in FIG. 9, the driving TFTs 60 in odd-numbered horizontal lines connected to the odd-numbered gate lines GL1, GL3, GL5, . . . are connected to data lines DL1 to DLm positioned in an −X direction with respect to the driving TFTs 60, respectively. The driving TFTs 60 in even-numbered horizontal lines connected to the even-numbered gate lines GL2, GL4, GL6, . . . are connected to data lines DL2 to DLm+2 positioned in an +X axis direction with respect to the driving TFTs 60, respectively.

The data driver 68 provides the video signals to the data lines DL1 to DLm+1 based on a column inversion driving method. Specifically, the data driver 68 provides the video signals having inverted polarities each with respect to the other to odd-number data lines DL1, DL3, . . . and the even-numbered data lines DL2, DL4, . . . for each frame. In particular, the data driver 68 provides the original video signals or the video signals shifted by one channel in a right direction to the liquid crystal cells arranged in the zigzag pattern with respect to the data lines DL1 to DLm+1. Moreover, because the data driver 68 is driven by the column inversion driving method and provides the original video signals or the video signals shifted by a channel in a right direction for each horizontal interval, the liquid crystal cells arranged in the zigzag pattern along the data lines DL1 to DLm+1 can be driven by a dot inversion method.

The driving TFT 60 is connected to its corresponding liquid crystal cell through both an i-numbered gate line and a j-numbered data line. Herein, each of i and j represents a natural number. Therefore, the driving TFT 60 provides a video signal from the j-numbered data line to the liquid crystal cell in response to a gate signal from the i-numbered gate line.

The pre-charging TFT 62 is connected to the corresponding liquid crystal cell through both an (i−l)-numbered gate line and a j-numbered data line. Therefore, the pre-charging TFT 62 provides a video signal from the j-numbered data line to the liquid crystal cell in response to a gate signal from the (i−l)-numbered gate line.

The video signal provided through the pre-charging TFT 62 is pre-charged in the liquid crystal cell. Specifically, a particular liquid crystal cell is pre-charged by the video signal provided through a previous horizontal line, and is charged by a desired video signal supplied thereto when a gate signal is provided to an i-numbered gate line. Accordingly, because the particular liquid crystal cell is pre-charged by the video signal provided through a previous horizontal line, the particular liquid crystal cell can be rapidly charged with a supplied video signal corresponding to a current horizontal line.

The pre-charging TFT 62 located at a first horizontal line is connected to the additionally formed first gate line GL0. The data driver 68 generates the dummy data in the form of a dummy video signal during the interval for driving the gate line GL0. Then, the liquid crystal cells located at the first horizontal line are pre-charged with the dummy video signal. The gate driver 70 sequentially provides gate signals to the gate lines GL0 to GLn.

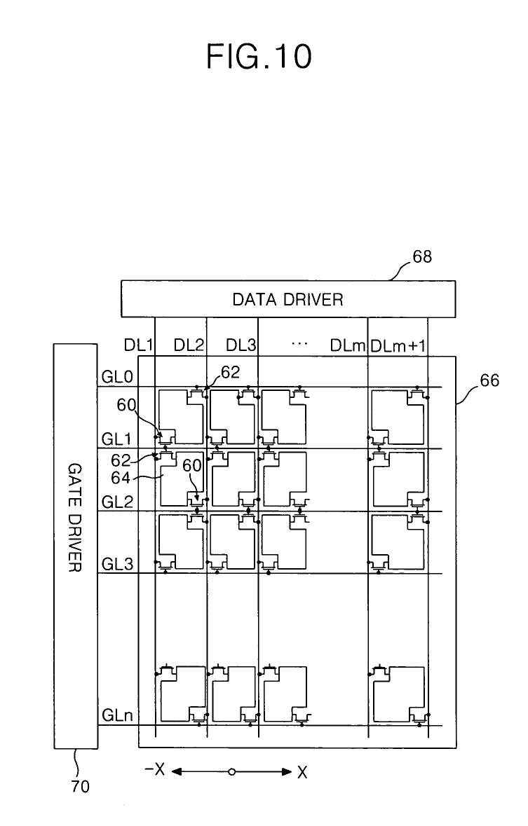

FIG. 10 is an exemplary schematic diagram of a liquid crystal display device in accordance with still another embodiment of the present invention. In FIG. 10, the location of the pre-charging TFTs 62 is modified. As depicted in FIG. 10, the pre-charging TFTs 62 and the driving TFTs 60 are connected to different data lines DL. Specifically, the driving TFT 60 is connected to both an i-numbered gate line and a j-numbered data line of a particular liquid crystal cell. The pre-charging TFT 62 is connected to both an (i−1)-numbered gate line and a (j+1)-numbered or a (j−1)-numbered data line of the particular corresponding liquid crystal cell. In this regard, if the driving TFT 60 is located in a −X direction, then the pre-charging TFT 62 is connected to both the (i−1)-numbered gate line and the 0+1)-numbered data line. Similarly, if the driving TFT 60 is located at a +X direction, then the pre-charging TFT 62 is connected to both the (i−1)-numbered gate line and the (j−1)-numbered data line.

As set forth above, in accordance with various embodiments of the present invention, the liquid crystal cells in a horizontal line are pre-charged using the video signal corresponding to that of a previous horizontal line. Accordingly, a desired video signal can be rapidly charged in the liquid crystal cells. As a result, the liquid crystal display device of the present invention is easily capable of displaying fast moving images.

It will be apparent to those skilled in the art that various modifications and variations can be made in embodiments the present invention without departing from the spirit or scope of the invention. Thus, it is intended that the present invention cover the modifications and variations of this invention provided they come within the scope of the appended claims and their equivalents.

What is claimed is:

1. A liquid crystal display device, comprising:
liquid crystal cells formed at crossings of data lines and gate lines;
driving thin film transistors connected to the liquid crystal cells, respectively, to provide a desired video signal to the liquid crystal cells; and
pre-charging thin film transistors connected to the liquid crystal cells, respectively, to pre-charge a specified voltage prior to providing the desired video signal to the liquid crystal cells.

2. The liquid crystal display device according to claim 1, wherein a pre-charging TFT is located at a k-numbered horizontal line, the pre-charging TFT charges a corresponding liquid crystal cell with a video signal corresponding to a (k−1)-numbered horizontal line, and k represents a natural number.

3. The liquid crystal display device according to claim 1, wherein a driving TFT is connected to an i-numbered gate line and a j-numbered data line of a particular liquid crystal cell, a pre-charging TFT is connected to an (i−1)-numbered gate line and a (j+1)-numbered data line of the particular liquid crystal cell, and each of i and j represents a natural number.

4. The liquid crystal display device according to claim 1, wherein a driving TFT is connected to an i-numbered gate line and a j-numbered data line of a particular liquid crystal cell, a pre-charging TFT is connected to an (i−1)-numbered gate line and the j-numbered data line of the particular liquid crystal cell, and each of i and j represents a natural number.

5. The liquid crystal display device according to claim 1, further comprising a dummy gate line, wherein the dummy gate line is connected to a dummy pre-charging TFT located at a first horizontal line.

6. The liquid crystal display device according to claim 5, further comprising a data driver for providing a dummy data to the data lines when a gate signal from the dummy gate line is provided to the pre-charging TFT.

7. A liquid crystal display device in which a liquid crystal panel includes liquid crystal cells formed at crossings of gate lines and data lines and arranged in a zigzag pattern along the data lines, the liquid crystal display device further comprising:
driving thin film transistors connected to the liquid crystal cells, respectively, and arranged in a zigzag pattern at a left side and a right side of the data lines, the driving thin film transistors for providing a desired video signal to the liquid crystal cells; and
pre-charging thin film transistors connected to the liquid crystal cells, respectively, the pre-charging thin film transistors for pre-charging a specified voltage in the liquid crystal cells prior to providing the desired video signal to the liquid crystal cells.

8. The liquid crystal display device according to claim 7, wherein a pre-charging TFT is located at a k-numbered horizontal line, the pre-charging TFT charges the liquid crystal cell using a video signal corresponding to a (k−1)-numbered horizontal line, and k represents a natural number.

9. The liquid crystal display device according to claim 7, wherein a driving TFT is connected to an i-numbered gate line and a j-numbered data line of a particular liquid crystal cell, a pre-charging TFT is connected to an (i−1)-numbered gate line and the j-numbered data line of the particular liquid crystal cell, and each of i and j represents a natural number.

10. The liquid crystal display device according to claim 7, wherein a driving TFT is connected to an i-numbered gate line and a j-numbered data line of a particular liquid crystal cell, a pre-charging TFT is connected to an (i−1)-numbered gate line and a (j+1)-numbered data line, and each of i and j represents a natural number.

11. The liquid crystal display device according to claim 7, wherein a driving TFT is connected to an i-numbered gate line and a j-numbered data line of a particular liquid crystal cell, a pre-charging TFT is connected to an (i-1)-numbered gate line and a (j−1)-numbered data line, and each of i and j represents a natural number.

12. The liquid crystal display device according to claim 7, further comprising a dummy gate line, the dummy gate line being connected to a dummy pre-charging TFT located at a first horizontal line.

13. The liquid crystal display device according to claim 12, further comprising a data driver for providing a dummy data to the data lines when a gate signal from the dummy gate line is provided to the pre-charging TFT.

14. A method of driving a liquid crystal display device comprising:
pre-charging liquid crystal cells located at a current horizontal line using a previous video signal corresponding to a previous horizontal line; and
providing a current video signal to the pre-charged liquid crystal cells to charge a desired video signal in the pre-charged liquid crystal cells, the current video signal corresponding to the current horizontal line.

15. The method according to claim 14, wherein the liquid crystal cells located at a k-numbered horizontal line are pre-charged by the video signal corresponding to a (k−1)-numbered horizontal line, and k represents a natural number.
